(19) United States
(12) Patent Application Publication
(10) Pub. No.: US 2007/0217435 A1
(43) Pub. Date: Sep. 20, 2007

(54) Method and apparatus to provide network event messages

(76) Inventors: Ronald T. Crocker, St. Charles, IL (US); John M. Harris, Chicago, IL (US); Sean S. Kelley, Barrington, IL (US); James A. Marocchi, Winfield, IL (US); Johanna A. Wild, Muenchen (DE)

Correspondence Address: MOTOROLA, INC., 1303 EAST ALGONQUIN ROAD, IL01/3RD, SCHAUMBURG, IL, 60196, US

(21) Appl. No.: 11/376,279

(22) Filed: Mar. 15, 2006

(51) Int. Cl. H04L 12/56; H04L 12/66

(52) U.S. Cl. 370/401; 370/463

(57) ABSTRACT

These various embodiments are usable in a context that comprises a first network that serves to communicatively couple an entity within a second network (which second network is different than the first network) with an end user platform. Pursuant to these teachings this entity is identified as having a predetermined status with respect to being provided with information regarding at least one first network event. When the first network event is detected within the first network, a message is provided to the entity regarding this first network event. By one approach the entity can acquire the indicated status via a subscription process.

### TECHNICAL FIELD

This invention relates generally to communication networks and more particularly to multi-network communications.

### BACKGROUND

Various communication networks are known in the art. This includes a wide variety of access networks that provide points of communications access to end user platforms. It sometimes becomes desirable to establish communications between an end user platform as is serviced by a first network (such as an access network) and an entity (such as, but certainly not limited to, an application server) within a second network (such as a network that serves as the core network for that entity). In such a case it can also be desirable to couple entity-specific behavior with triggers that are specific to the first network. This, however, typically entails imbuing such a first network with considerable entity-specific functionality.

While such is possible, there are numerous disincentives to challenge the system designer and administrator. In general this can be time consuming, error prone, and costly to implement. More specifically, making changes to reflect the necessary functionality may become necessary with most or even all new services and/or applications as they are introduced. In addition, in many cases it may be relatively impossible for the first network to effect the desired level of entity-specific behavior (for example, the entity-specific functionality may relate to data packet interrogation which the first network may be unable to accomplish due to encryption of the packets).

### BRIEF DESCRIPTION OF THE DRAWINGS

The above needs are at least partially met through provision of the method and apparatus to provide network event messages described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, these various embodiments are usable in a context that comprises a first network that serves to communicatively couple an entity within a second network (which second network is different than the first network) with an end user platform. Pursuant to these teachings this entity is identified as having a predetermined status with respect to being provided with information regarding at least one first network event. When the first network event is detected within the first network, a message is provided to the entity regarding this first network event. By one approach the entity can acquire the indicated status via a subscription process.

The specifics of the first network event can and will vary with respect to the application setting. In many cases, useful network events will relate to actions that the first network has taken with respect to establishing communications with the end user platform and/or responsive actions that have been taken by the end user platform. By one approach the notification message regarding the first network event can employ semantics that are not fully compatible with messaging semantics as are ordinarily otherwise substantially employed by the first network. The employed semantics, for example, can comprise semantics that are agnostic with respect to a plurality of different types of networks. This, in turn, can aid in ensuring compatible interactions as between a variety of otherwise incompatible elements.

So configured, an access network can permit, for example, an application server to subscribe to information regarding high-level events within the access network (as versus, for example, more specific or higher resolution information that may not be readily communicable by the access network). In many cases the information provided may effectively represent more of a hint regarding conditions of interest rather than a specific confirmation of a high resolution inquiry. For example, the message might indicate that a given end user platform has responded to a page request but be relatively devoid regarding the specifics of that response. Notwithstanding a possible lack of specificity, many applications will nevertheless be able to make considerable use of such messages with respect to furthering their native functionality.

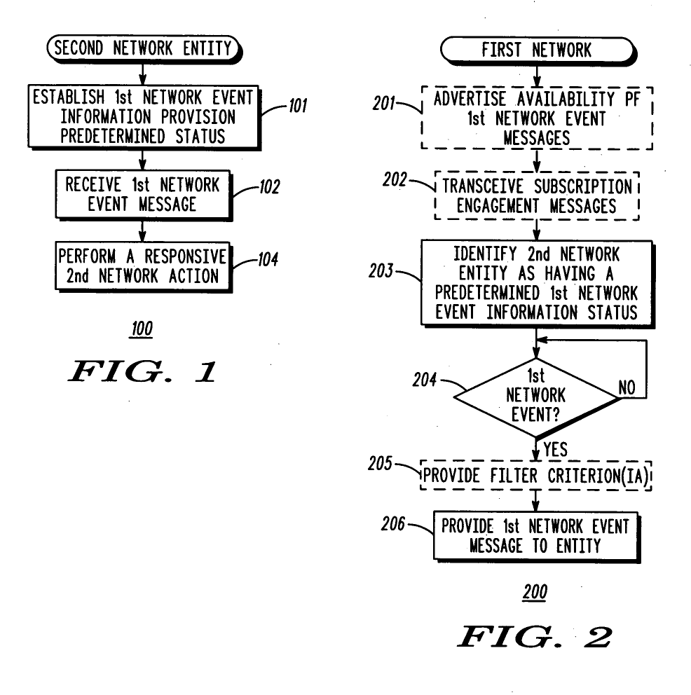

These and other benefits may become clearer upon making a thorough review and study of the following detailed description. Referring now to the drawings, and in particular to FIG. 1, a process 100 that can be used by an entity (such as, but not limited to, an application server as is known in the art) when interacting with a first network (such as, but not limited to, a Radio Access Network (RAN) as is known in the art) from a second network (wherein the second network is different than the first network) to communicatively couple to an end user platform can provide for establishing 101 a predetermined status with respect to being provided with information regarding at least one first network event. This comprises, in at least some application settings, effectively configuring a predetermined trigger by which to provide first network-based status information to the entity.

This step of establishing 101 this status can comprise, for example, receiving advertising which indicates that subscriptions corresponding to first network event messages are available. The entity can then, for example, transmit one or more messages as required to facilitate engaging a subscription that corresponds to receiving such messages. The content of such a message will of course likely vary from one application setting to another. In general, however, it may be useful to provide identifying information (such as an address) for the subscribing entity itself, identifying information (such as an address) for the end user platform, and identification of the first network event.

This step can comprise establishing such status with respect to only a single kind of first network event if desired, but this step can also comprise establishing such status with respect to a plurality of different first network events. Such subscriptions can be instigated as often as may be appropriate to the needs and/or capabilities of a given application setting. In many cases, however, it may be useful to arrange for such a subscription on a per-call basis.

Those skilled in the art will recognize and understand that any of a wide variety of events can comprise the aforementioned first network event. Illustrative examples include, but are not limited to:
a page having been sent via the first network to the end user platform;
a page response from the end user platform having been received by the first network;
a determination that the end user platform is presently busy;
an origination request from the end user platform having been received by the first network;
an establishment of a bearer channel between the first network and the end user platform;
a normal loss of the bearer channel between the first network and the end user platform;
an abnormal loss of the bearer channel between the first network and the end user platform;
a reselection event (where reselection is understood to comprise, for example, when an end user platform begins switching from one access network point of attachment to another point of attachment, from one attachment protocol/technology to another, or even from one end user platform to another); and/or
a particular level of at least one of link level quality, signal strength, and quality of service.

When the network entity receives 102 a message regarding the subscribed-to first network event, the entity can then responsively perform 103 a second network action as a function, at least in part, of being informed of the first network event. Additional detail appears below with respect to the nature of substance of this message.

Referring now to FIG. 2, a corresponding process 200 suitable for implementation by the first network will be described. As noted above, it may be desirable for the second network entity to receive advertisements regarding the availability of first network event messages. Accordingly, if desired, this process 200 can optionally provide for advertising 201 to the entity that subscriptions corresponding to first network event message are available. Advertising the availability of information in this manner comprises a generally well understood technique and requires no further specific elaboration here aside from noting that such a process 200 may then further optionally provide for transceiving 202 messages with the second network entity to facilitate engaging a subscription corresponding to such first network event messages. This could comprise, for example, receiving a message from the entity that comprises a request to subscribe to notifications regarding at least one or even a plurality of different network events.

By one approach a subscription of this type can persist until specifically cancelled or terminated by, for example, the second network entity. By another approach, the subscription will correspond instead to a particular duration. This particular duration can be deterministic or non-deterministic depending upon the preferences and needs of a given application setting. Examples include, but are not limited to,
the duration of a communication session between the entity and the end user platform;
the duration of a communication session between the first network and the end user platform;
a particular predetermined period of time; and/or
an occurrence of a predetermined circumstance;
to note but a few illustrative examples.

This process 200 then provides for identifying 203 the entity as having the aforementioned predetermined status with respect to being provided with information regarding the first network event (or events) of interest. The first network then detects 204 when the first network event occurs. Upon detecting 204 such an event this process 200 can then provide 206 the aforementioned first network event message to the second network entity.

As noted earlier, in many cases the second network entity will not be fully informed of all intricacies regarding the functionality and operation of the first network. Accordingly, in many instances it will be helpful if the first network events themselves comprise relatively high level events such as those that are presented above as versus events that tend to be more unique to a given network. In effect, these first network events can be viewed as hints regarding first network and/or end user platform status and activities. Though less than fully specific, however, such hints will often be sufficient to permit the second network entity to nevertheless facilitate its own communication needs with respect to that end user platform.

Similarly, it can be helpful to also effect provision 206 of the first network event message using semantics that are relatively agnostic with respect to a plurality of different kinds of first networks (such as, but not limited to, 802-family-based networks, General Packet Radio Service-based networks, CDMA-2000-based networks, wired access networks, and so forth). This approach can help to ensure that a given entity can successfully receive and understand an event message as described herein without requiring a native capability of understanding the specific message semantics of a wide ranging variety of first networks. Accordingly, those skilled in the art will recognize that the aforementioned message may optionally be provided using semantics that are not fully compatible with the messaging semantics that are ordinarily substantially employed by the first network and/or having timing characteristics that are not fully compatible with timing characteristics as are ordinarily substantially employed by the first network.

As one simple illustrative example, consider a first network event message “page response.” There are networks, such as CDMA-2000 networks, that have a very direct corollary to such an event (i.e., a message comprising a transmitted response by an end user platform to a page issued by the network). There are other networks, however, that have no directly similar corollary (802.16e networks, for example, support no such event). Notwithstanding the lack of a directly similar corollary, however, there may be relevant counterpart events such as a connection request message, a ranging purpose indication, or a link maintenance handshake message, to note but a few. These can be viewed as being relevant counterpart events because each of these events serves to reflect an active availability of the end user platform. Accordingly, a message such as “page response” can be understood to refer for these purposes as a more agnostic representation that the end user platform is active and available. The second network entity, in turn, can potentially employ such a higher level representation regarding the availability of the end user platform to inform its own activities and functionality.

If desired, upon detecting 204 a first network event of interest, this process 200 can optionally also facilitate providing 206 the aforementioned message as a function, at least in part, of a previously provided 205 filter criterion (or criteria). Such a filter criterion can serve, for example, to aid with processing the first network event to determine whether to actually provide the corresponding message to the entity. The filter criterion, when employed, can be locally provided or can, if desired, be provided by the second network entity. The latter can occur via, for example, a subscription protocol that accommodates presentation of such content. By one approach such filtering could be based on local first network policy (which may be setup due to operational reasons, charging reasons, and so forth). Other examples could include filtering based on time of day, access network load factors, user subscription-based parameters, and so forth. It would also be possible for these filter criteria to include the number of times events occur and/or thresholds as pertain to other kinds of measurable activity or results (such as, for example, quality of service metrics such as data rate, delay, and the like).

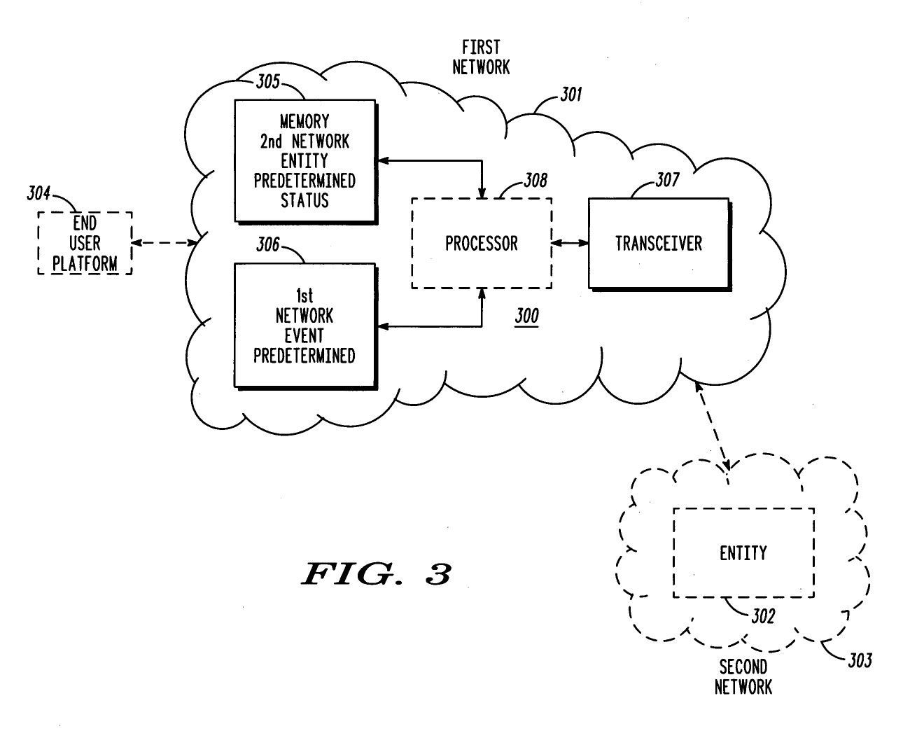

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment the apparatus 300 comprises a part of a first network 301 which might comprise, for example, a radio access network. This first network 301 serves, at least in part, to communicatively couple an entity 302 (such as an application server) within a second network 303 with an end user platform 304 such as, but not limited to, a wireless two-way communications device.

This apparatus 300 comprises a network entity having a memory 305 that contains information which identifies the second network entity 302 as having a predetermined status with respect to being provided with information regarding at least one first network event as has been discussed above. This network entity further comprises a first network event detector 306 to facilitate detection of the network event of interest. The precise nature of this detector will of course vary with the application setting and with the particular network event or events to be detected. Those skilled in the art will recognize that various ways and means already exist with respect to detecting any of a wide variety of network events of interest and that other detectors will no doubt be developed hereafter. Furthermore, these teachings are relatively insensitive with respect to the selection of any particular detector or technique of detection. Therefore, for the sake of brevity further elaboration and detail regarding such detectors will not be provided here.

This apparatus 300 also comprises a transmitter (represented here by a transceiver 307) that is responsive to the memory 305 and the first network event detector 306 to facilitate the transmission of messages regarding detected first network events to the second network entity 302 in accordance with the teachings provided above. In many instances it will also be useful to optionally provide a processor 308 that operably couples to the above-described components. By one approach, this processor 308 is configured and arranged to effect the various steps and functionality described herein. This can include, for example, determining, upon detecting a first network event, whether a corresponding message is to be transmitted to the second network entity 302. Such a determination can be based, for example, upon the aforementioned filter criterion.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

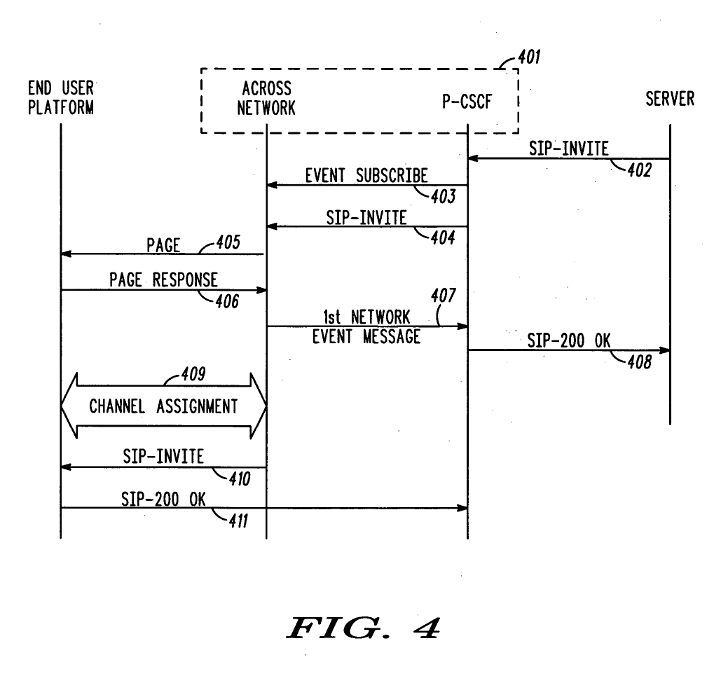

Referring now to FIG. 4, an illustrative call flow provides a simple example that accords with these teachings. Those skilled in the art will recognize that the specifics of this example are offered for the sake of illustration and do not represent an exhaustive presentation of all practices as would also accord with these teachings. In this example an application server seeks to establish connectivity with an end user platform via a network 401 that comprises both an access network and a Proxy-Call Session Control Function (P-CSCF).

In this example the server transmits a session initiation protocol INVITE message 402 to the P-CSCF. The latter then transmits to the access network an event subscription request 403 as per the description provided above. The INVITE message is then forwarded 404. In this example, the INVITE message 404 follows the event subscription message 403, but this order could of course be reversed if desired. In this example, the access network responds to the event subscription message 403 by registering the server as having the corresponding aforementioned status. Here, for the sake of example, it will be presumed that the network event of interest comprises an end user platform page response.

The access network then transmits a page message 405 to the end user platform as per the dictates of the access network protocol. The end user platform responds with a page response message 406. Receipt of this page response message 406 comprises the network event of interest; that is, this page response comprises the network event regarding which the server wishes to remain informed. Therefore, upon detecting this event, and presuming that there are no filter-based reasons to act otherwise, the access network transmits a message 407 regarding this network event to the P-CSCF. Those skilled in the art will recognize that other network events as are likely also occurring are not being reported to the server as the server has not placed a subscription with respect to such events.

As already noted above, this message 407 may comprise a relatively agnostically-formed/framed message and, in particular, may lack certain elements of specificity that were otherwise contained in the page response 406 itself. The P-CSCF, in turn, now transmits a corresponding session initiation protocol 200 OK message 408 to the server (presuming that this comprises an application appropriate response in this example).

This example then concludes with the access network and end user platform effecting a channel assignment 409, following which the access network is able to finally forward a session initiation protocol INVITE message 410 to the end user platform. The latter can then respond with a corresponding 200 OK message 411 via the access network to the P-CSCF. Note, however, that the latter does not forward that 200 OK message on to the server as a 200 OK message 408 has already been provided to the server based upon the detected network event message 407. Accordingly, a more efficient and potentially speedier transaction may result as will be well appreciated by those skilled in the art.

These teachings are readily employed to facilitate communications between a core network and an outlying terminal via an access network of convenience. More particularly, the network event information, though potentially presented at a relatively high level, can nevertheless enable better performance when used in conjunction with a variety of applications. This better performance can result, for example, due to the coupling of application-specific behavior with access network-specific triggers. Those skilled in the art will appreciate that these benefits accrue notwithstanding that such a core network is, and can remain, essentially ignorant of many (or most) innerworkings of the access network. These teachings are particularly leverageable when an application makes use of events that tend to be relatively common across a variety of access network technologies as such events are readily expressed with the kinds of messages contemplated herein within a corresponding need to present additional event detail.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for use with a first network, which first network serves to communicatively couple an entity within a second network that is different than the first network and an end user platform, the method comprising:
identifying the entity as having a predetermined status with respect to being provided with information regarding at least one first network event;
detecting within the first network the first network event;
providing a message to the entity regarding the first network event.

2. The method of claim 1 wherein the first network comprises a Radio Access Network (RAN) and the entity comprises an application server.

3. The method of claim 1 wherein identifying the entity as having a predetermined status with respect to being provided with information regarding at least one first network event comprises:
receiving a message from the entity comprising a request to subscribe to notifications regarding at least one first network event.

4. The method of claim 3 wherein receiving a message from the entity comprising a request to subscribe to notifications regarding at least one first network event comprises receiving a message from the entity comprising a request to subscribe to notifications regarding a plurality of different network events.

5. The method of claim 3 wherein receiving a message from the entity comprising a request to subscribe to notifications regarding at least one first network event comprises receiving a message from the entity comprising a request to subscribe to notifications regarding at least one first network event for a particular duration.

6. The method of claim 5 wherein the particular duration substantially corresponds to at least one of:
a first duration of a first session between the entity and the end user platform;
a second duration of a second session between the first network and the end user platform;
a particular predetermined period of time;
an occurrence of a predetermined circumstance.

7. The method of claim 1 wherein the first network event comprises at least one of:
a page having been sent via the first network to the end user platform;
a page response from the end user platform having been received by the first network;
a determination that the end user platform is presently busy;
an origination request from the end user platform having been received by the first network;
an establishment of a bearer channel between the first network and the end user platform;
a normal loss of the bearer channel between the first network and the end user platform;
an abnormal loss of the bearer channel between the first network and the end user platform;
a reselection event;
a particular level of at least one of link level quality, signal strength, and quality of service.

8. The method of claim 1 wherein providing a message to the entity regarding the first network event comprises providing at least one of:
a message using semantics that are not fully compatible with messaging semantics as are ordinarily otherwise substantially employed by the first network;
a message having timing characteristics that are not fully compatible with timing characteristics as are ordinarily otherwise substantially employed by the first network.

9. The method of claim 8 wherein providing a message using semantics that are not fully compatible with messaging semantics as are ordinarily otherwise substantially employed by the first network further comprises using semantics that are agnostic with respect to a plurality of different types of first networks.

10. The method of claim 9 wherein the plurality of different first networks comprise, at least in part:
an 802-family-based network;
a General Packet Radio Service-based network;
an CDMA-2000-based network;
a wired access network.

11. The method of claim 1 further comprising at least one of:
advertising to the entity that subscriptions corresponding to first network event messages are available;
transceiving messages to facilitate engaging a subscription corresponding to the first network event messages.

12. The method of claim 1 further comprising:
providing at least one filter criterion;
and wherein providing a message to the entity regarding the first network event further comprises:
processing the first network event with respect to the at least one filter criterion to determine whether to provide the message to the entity regarding the first network event.

13. A method for use when interacting with a first network from a second network that is different than the first network to communicatively couple to an end user platform, the method comprising:
at an entity within the second network:
establishing a predetermined status with respect to being provided with information regarding at least one first network event;
receiving a message regarding the first network event;
performing a second network action as a function, at least in part, of being informed of the first network event.

14. The method of claim 13 wherein the first network comprises a Radio Access Network (RAN) and the entity comprises an application server.

15. The method of claim 13 wherein establishing a predetermined status with respect to being provided with information regarding at least one first network event comprises:
receiving advertising indicating that subscriptions corresponding to first network event messages are available;
transmitting at least one message to facilitate engaging a subscription corresponding to the first network event messages.

16. The method of claim 13 wherein establishing a predetermined status with respect to being provided with information regarding at least one first network event comprises establishing a predetermined status with respect to being provided with information regarding a plurality of different first network events.

17. The method of claim 13 wherein the first network event comprises at least one of:
a page having been sent via the first network to the end user platform;
a page response from the end user platform having been received by the first network;
a determination that the end user platform is presently busy;
an origination request from the end user platform having been received by the first network;
an establishment of a bearer channel between the first network and the end user platform;
a normal loss of the bearer channel between the first network and the end user platform;
an abnormal loss of the bearer channel between the first network and the end user platform;
a reselection event;
a particular level of at least one of link level quality, signal strength, and quality of service.

18. The method of claim 13 wherein receiving a message regarding the first network event comprises at least one of:
receiving a message that uses semantics that are not fully compatible with messaging semantics as are ordinarily otherwise substantially employed by the first network and that are semantically agnostic with respect to a plurality of different types of first networks;
receiving a message having timing characteristics that are not fully compatible with timing characteristics as are ordinarily otherwise substantially employed by the first network.

19. A network entity for use in a first network, which first network serves to communicatively couple an entity within a second network that is different than the first network and an end user platform, the network entity comprising:
a memory containing information identifying the entity as having a predetermined status with respect to being provided with information regarding at least one first network event;
a first network event detector;
a first network event message transmitter being responsive to the memory and the first network event detector and being configured and arranged to transmit to the entity a message regarding the first network event.

20. The network entity of claim 19 further comprising:
processor means operably coupled to the memory, the first network event detector, and the first network event message transmitter for determining, upon detection of the first network event, whether a corresponding message is to be transmitted to the entity regarding the first network event.
